(19) United States
(12) Patent Application Publication
(10) Pub. No.: US 2025/0266442 A1
(43) Pub. Date: Aug. 21, 2025

(54) POSITIVE ELECTRODE ACTIVE SUBSTANCE FOR LITHIUM SECONDARY BATTERY, METHOD FOR PRODUCING THE SAME, AND LITHIUM SECONDARY BATTERY

(71) Applicant: NIPPON CHEMICAL INDUSTRIAL CO., LTD., Tokyo (JP)

(72) Inventor: Naoshi Watanabe, Tokyo (JP)

(73) Assignee: NIPPON CHEMICAL INDUSTRIAL CO., LTD., Tokyo (JP)

(21) Appl. No.: 18/857,300

(22) PCT Filed: Apr. 21, 2023
(86) PCT No.: PCT/JP2023/015906

§ 371 Date: Oct. 16, 2024

(30) Foreign Application Priority Data
Apr. 26, 2022 (JP) 2022-072278

(51) Int. Cl. H01M 4/525; C01G 53/504; H01M 10/052

(52) U.S. Cl. CPC H01M 4/525; C01G 53/504; H01M 10/052; C01P 2002/50; C01P 2002/72; C01P 2002/85; C01P 2004/03; C01P 2004/61; C01P 2004/82; C01P 2006/11; C01P 2006/12; C01P 2006/40

(57) ABSTRACT

The positive electrode active substance for a lithium secondary battery comprises a lithium nickel manganese cobalt composite oxide particle represented by the following general formula (1): LiₓNi_{y}Mn_{z}CoₜMₚO₁₊ₓ. M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1; and being made to contain Ti as solid solution. The lithium nickel manganese cobalt composite oxide particle exhibits a single phase in X-ray diffractometry.

### TECHNICAL FIELD

The present invention relates to a positive electrode active substance for a lithium secondary battery, a method for producing the same, and a lithium secondary battery.

### BACKGROUND ART

As a positive electrode active substance for lithium secondary batteries, lithium cobaltate has conventionally been used. Since cobalt is a rare metal, however, lithium nickel manganese cobalt composite oxides low in the content of cobalt are developed (for example, see Patent Literatures 1 and 2).

It is known that a lithium secondary battery using a lithium nickel manganese cobalt composite oxide as a positive electrode active substance becomes enabled to be reduced in the cost and comes to have a higher capacity than lithium cobaltate, by regulating the atomic ratios of nickel, manganese and cobalt contained in the composite oxide (for example, see Patent Literature 3).

However, even these methods using conventional technologies still have such a problem that in the lithium secondary batteries using a lithium nickel manganese cobalt composite oxide as their positive electrode active substances, the cycle characteristics are degraded.

As a method of improving the cycle characteristics of the lithium secondary batteries using a lithium nickel manganese cobalt composite oxide as their positive electrode active substances, there is proposed a method of coating the particle surface of the lithium nickel manganese cobalt composite oxide with a Ti-containing compound (for example, see Patent Literature 4, Patent Literature 5 and the like).

As a method of coating the particle surface of a lithium nickel manganese cobalt composite oxide with a Ti-containing compound, in Patent Literatures 4 and 5, there is proposed a method in which: an alkoxide monomer or oligomer composed of an organometal compound of Ti or the like, and an alcohol such as 2-propanol are mixed, and thereafter, a chelate agent such as acetylacetone is added and water is further added to prepare a dispersion in which a precursor of Ti-containing microparticulate having an average particle diameter of 1 to 20 nm is dispersed; and the particle surface of the lithium nickel manganese cobalt composite oxide is subjected to a coating treatment with the dispersion; and then, the resultant is subjected to a heat treatment.

### CITATION LIST

### Patent Literature

Patent Literature 1: International Publication No. WO2004/092073
Patent Literature 2: Japanese Patent Laid-Open No. 2005-25975
Patent Literature 3: Japanese Patent Laid-Open No. 2011-23120
Patent Literature 4: Japanese Patent Laid-Open No. 2016-24968
Patent Literature 5: Japanese Patent Laid-Open No. 2016-72071

### SUMMARY OF INVENTION

### Technical Problem

In recent years, use of lithium secondary batteries in the automobile field such as electric vehicles, hybrid cars and plug-in hybrid cars has been studied. Hence, in lithium secondary batteries using a lithium nickel manganese cobalt composite oxide as their positive electrode active substances, further improvement in the cycle characteristics is demanded.

Accordingly, an object of the present invention is to provide a positive electrode active substance for a lithium secondary battery which can impart excellent cycle characteristics to the lithium secondary battery using a lithium nickel manganese cobalt composite oxide as its positive electrode active substance, and the lithium secondary battery excellent in the cycle characteristics.

### Solution to Problem

As a result of making exhaustive studies in consideration of the above real situation, the present inventors have found that a lithium secondary battery using, as its positive electrode active substance, a lithium nickel manganese cobalt composite oxide particle represented by the general formula (1) containing Ti as solid solution and having, toward the depth direction from the surface, a region where Ti is contained as solid solution in a predetermined atomic % by mol or higher, and a region where the amount of Ti contained as solid solution is lower than the predetermined atomic & by mol; and being of a single phase in X-ray diffractometry makes one excellent in the cycle characteristics, and this finding has led to the completion of the present invention.

That is, the present invention (1) provides a positive electrode active substance for a lithium secondary battery, the positive electrode active substance comprising a lithium nickel manganese cobalt composite oxide particle represented by the following general formula (1):

LiₓNi_{y}Mn_{z}CoₜMₚO₁₊ₓ (1)

wherein M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1; and being made to contain Ti as solid solution,
wherein the lithium nickel manganese cobalt composite oxide particle has, in the depth direction from the surface, a first region where the atomic & by mol of Ti with respect to the total of Ni, Co and Ti is 4.0 at % or higher, and a second region where the atomic % by mol of Ti with respect to the total of Ni, Co and Ti is lower than 4.0 at %; and
comprises a lithium nickel manganese cobalt composite oxide represented by the general formula (1), exhibiting a single phase in X-ray diffractometry.

Then, the present invention (2) provides the positive electrode active substance for a lithium secondary battery according to (1), wherein the content of Ti in terms of atom is, with respect to the total amount of Ni, Mn, Co and M in the lithium nickel manganese cobalt composite oxide particle, 0.01 to 5.00% by mol as Ti.

Then, the present invention (3) provides the positive electrode active substance for a lithium secondary battery according to (1) or (2), wherein the content of remaining alkali is 1.20% by mass or lower.

Then, the present invention (4) provides the positive electrode active substance for a lithium secondary battery according to any one of (1) to (3), wherein the atomic % by mol of Ti in the particle surface with respect to the total of Ni, Co and Ti therein is 6.0 at % or higher.

Then, the present invention (5) provides the positive electrode active substance for a lithium secondary battery according to any one of (1) to (4), wherein the ratio (A/B) of the atomic & by mol (A) of Ti with respect to the total of Ni, Co and Ti at 0 nm in the depth direction to the atomic % by mol (B) of Ti with respect to the total of Ni, Co and Ti at 330 nm in the depth direction is 10.0 or higher.

Then, the present invention (6) provides the positive electrode active substance for a lithium secondary battery according to any one of (1) to (5), wherein the positive electrode active substance is obtained by dry mixing a lithium nickel manganese cobalt composite oxide particle represented by the following general formula (1):

LiₓNi_{y}Mn_{z}CoₜMₚO₁₊ₓ (1)

wherein M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1, with a Ti-containing oxide to adhere the Ti-containing oxide on the particle surface of the lithium nickel manganese cobalt composite oxide particle to thereby obtain a composite oxide particle having the Ti-containing oxide adhered thereon, and thereafter heat-treating the composite oxide particle having the Ti-containing oxide adhered thereon at 750° C. or higher and 1,000° C. or lower.

Then, the present invention (7) provides the positive electrode active substance for a lithium secondary battery according to any one of (1) to (6), wherein the positive electrode active substance is a mixture of large particles having an average particle diameter of 7.5 to 30.0 μm and small particles having an average particle diameter of 0.50 to 7.5 μm.

Then, the present invention (8) provides the positive electrode active substance for a lithium secondary battery according to (7), wherein the mixing ratio of the large particles to the small particles is, in mass ratio, from 7:13 to 19:1.

Then, the present invention (9) provides the positive electrode active substance for a lithium secondary battery according to (7) or (8), wherein the mixture has a pressure density in compression treatment at 0.65 tonf/cm² of 2.7 g/cm³ or higher.

Then, the present invention (10) provides a method for producing a positive electrode active substance for a lithium secondary battery, the method comprising: dry mixing a lithium nickel manganese cobalt composite oxide particle represented by the following general formula (1):

LiₓNi_{y}Mn_{z}CoₜMₚO₁₊ₓ (1)

wherein M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1, with a Ti-containing oxide to adhere the Ti-containing oxide on the particle surface of the lithium nickel manganese cobalt composite oxide particle to thereby obtain a composite oxide particle having the Ti-containing oxide adhered thereon; and thereafter heat-treating the composite oxide particle having the Ti-containing oxide adhered thereon at 750° C. or higher and 1,000° C. or lower.

Then, the present invention (11) provides the method for producing a positive electrode active substance for a lithium secondary battery according to (10), wherein the Ti-containing oxide is TiO₂.

Then, the present invention (12) provides a lithium secondary battery, the lithium secondary battery using a positive electrode active substance for a lithium secondary battery according to any one of (1) to (9).

### Advantageous Effects of Invention

The positive electrode active substance for a lithium secondary battery of the present invention can impart excellent cycle characteristics to a lithium secondary battery using the lithium nickel manganese cobalt composite oxide as its positive electrode active substance, and the positive electrode active substance for a lithium secondary battery of the present invention can be used to provide a lithium secondary battery excellent in the cycle characteristics.

### BRIEF DESCRIPTION OF DRAWINGS

FIG. 1 is an X-ray diffraction diagram of a positive electrode active substance sample obtained in Example 1.

FIG. 2 is an X-ray diffraction diagram of a positive electrode active substance sample obtained in Example 2.

FIG. 3 is an X-ray diffraction diagram of a positive electrode active substance sample obtained in Comparative Example 3.

FIG. 4 is a diagram showing changes in the atomic % by mol of Ti in the depth direction of the positive electrode active substance sample obtained in Example 1.

FIG. 5 is a diagram showing changes in the atomic % by mol of Ti in the depth direction of a positive electrode active substance sample obtained in Comparative Example 1.

FIG. 6 is secondary electron images and Ti element mapping images obtained by SEM-EDX analysis of the positive electrode active substance samples obtained in Example 2 and Comparative Example 3.

### DESCRIPTION OF EMBODIMENTS

The positive electrode active substance for a lithium secondary battery of the present invention comprises a lithium nickel manganese cobalt composite oxide particle represented by the following general formula (1):

LiₓNi_{y}Mn_{z}CoₜMₚO₁₊ₓ (1)

wherein M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1; and being made to contain Ti as solid solution,
wherein the lithium nickel manganese cobalt composite oxide particle has, in the depth direction from the surface, a first region where the atomic & by mol of Ti with respect to the total of Ni, Co and Ti is 4.0 at % or higher, and a second region where the atomic & by mol of Ti with respect to the total of Ni, Co and Ti is lower than 4.0 at %; and
comprises a lithium nickel manganese cobalt composite oxide represented by the general formula (1), exhibiting a single phase in X-ray diffractometry.

The positive electrode active substance for a lithium secondary battery of the present invention is a lithium nickel manganese cobalt composite oxide particle represented by the general formula (1) and being made to contain Ti as solid solution. That is, the positive electrode active substance for a lithium secondary battery of the present invention is a lithium nickel manganese cobalt composite oxide particle represented by the general formula (1) containing Ti as solid solution. Then, in the positive electrode active substance for a lithium secondary battery of the present invention, there are formed, in the depth direction from the particle surface of the lithium nickel manganese cobalt composite oxide particle, a first region where the amount of Ti contained as solid solution is a predetermined & by mol or larger, and a second region where the amount of Ti contained as solid solution is smaller than the predetermined % by mol. Then, the positive electrode active substance for a lithium secondary battery of the present invention is an aggregate of the lithium nickel manganese cobalt composite oxide particle, exhibiting a single phase in X-ray diffractometry.

Accordingly, the positive electrode active substance for a lithium secondary battery of the present invention is differentiated from a lithium nickel manganese cobalt composite oxide particle as a core particle having an oxide of Ti adhered and present on the surface thereof.

In the lithium nickel manganese cobalt composite oxide particle as a core particle having an oxide of Ti adhered and present on the surface thereof, though depending on the amount of the oxide of Ti adhered, when the particle is subjected to X-ray diffractometry, the oxide of Ti, other than the lithium nickel manganese cobalt composite oxide particle as a core particle, is detected as a heterophase.

By contrast, in the lithium nickel manganese cobalt composite oxide particle represented by the general formula (1) and made to contain Ti as solid solution, relevant to the positive electrode active substance for a lithium secondary battery of the present invention, when being subjected to X-ray diffractometry, substantially no heterophase of the oxide of Ti is detected. That is, the positive electrode active substance for a lithium secondary battery of the present invention is the lithium nickel manganese cobalt composite oxide particle represented by the general formula (1), exhibiting a single phase in X-ray diffractometry.

Then, in the case where a Ti-containing oxide is adhered and present on the particle surface of the lithium nickel manganese cobalt composite oxide particle, when the particle surface of the lithium nickel manganese cobalt composite oxide particle is analyzed by using Ti element mapping analysis by SEM-EDX at an enlarging magnification of 10,000 to 30,000 times, Ti is observed to be in such a state that Ti is distributed in a nonuniform manner including maldistribution on the particle surface of the lithium nickel manganese cobalt composite oxide particle.

By contrast, in the lithium nickel manganese cobalt composite oxide particle represented by the general formula (1) and made to contain Ti as solid solution, relevant to the positive electrode active substance for a lithium secondary battery of the present invention, when the particle surface of the lithium nickel manganese cobalt composite oxide particle is analyzed by using Ti element mapping analysis by SEM-EDX at an enlarging magnification of 10,000 to 30,000 times, Ti is observed to be in such a state that Ti is distributed uniformly like Co, Ni, Mn and the like.

In the positive electrode active substance for a lithium secondary battery of the present invention, the lithium nickel manganese cobalt composite oxide particle to become an object containing Ti as solid solution is a composite oxide containing lithium, nickel, manganese and cobalt, and represented by the following general formula (1).

LiₓNi_{y}Mn_{z}CoₜMₚO₁₊ₓ (1)

wherein M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1.

x in the general formula (1) is 0.98≤x≤1.20. x is, in that the initial capacity becomes high, preferably 1.00≤x≤1.10. Then, y in the general formula (1) is 0.30≤y<1.00. y is, in that the initial capacity and the cycle characteristics both can be satisfied simultaneously, preferably 0.50≤y≤0.95 and especially preferably 0.60≤y≤0.90. Then, z in the general formula (1) is 0<z≤0.50. z is, in respect of being excellent in the safety, preferably 0.025≤z≤0.45. Then, t is 0<t≤0.50. t is, in respect of being excellent in the safety, preferably 0.025≤t≤0.45. y+z+t+p=1. y/z is preferably (y/z)>1 and especially preferably (y/z)≥1.5, and more preferably 3≤(y/z)≤38.

Then, M in the formula is, aiming at improving the battery performance including the cycle characteristics and the safety, a metal element, as required, made to be contained in the lithium nickel manganese cobalt composite oxide represented by the general formula (1); and M includes one or two or more metal elements selected from Al, Zr, Cu, Fe, Sr, Ca, V, Mo, Bi, Nb, Si, Zn, Ga, Ge, Sn, Ba, W, Na and K. p in the general formula (1) is 0≤p≤0.050, and preferably 0.0001≤p≤0.045.

In the positive electrode active substance for a lithium secondary battery of the present invention, the lithium nickel manganese cobalt composite oxide particle made to contain Ti as solid solution has, toward the depth direction from the surface thereof, a first region where Ti is contained as solid solution in a predetermined % by mol or higher, and a second region where Ti is contained as solid solution in lower than the predetermined % by mol.

The first region is a region where the percentage (atomic & by mol) of the molar number of Ti in terms of atom to the total molar number of Ni, Co and Ti in terms of atom calculated by the following expression:

$$Atomic \% by mol of Ti to the total of Ni , Co and Ti = ( Ti / ( Ni + Co + Ti ) ) \times 100$$

wherein Ni, Co and Ti are molar numbers in terms of atom, is 4.0 at % or higher.

The first region is formed preferably in at least 5 nm or deeper in the depth direction from the surface of the lithium nickel manganese cobalt composite oxide particle; more preferably in 10 nm or deeper; and still more preferably in 15 nm or deeper. Then, the upper limit value of the forming range of the first region is preferably 100 nm or shallower in the depth direction; more preferably 60 nm or shallower; and still more preferably 50 nm or shallower. Due to that the first region is formed in the above range, the lithium ion conduction in the second region is held, while the dissolving-out of the transition metals from the lithium nickel manganese cobalt composite oxide particle interior is suppressed and the cycle characteristics are improved.

The second region is a region where the percentage (atomic % by mol) of the molar number of Ti in terms of atom to the total molar number of Ni, Co and Ti in terms of atom calculated by the following expression:

$$Atomic \% by mol of Ti to the total of Ni , Co and Ti = ( Ti / ( Ni + Co + Ti ) ) \times 100$$

wherein Ni, Co and Ti are molar numbers in terms of atom, is lower than 4.0 at %.

The second region is a region where no Ti is contained, or even when Ti is contained, the percentage (atomic % by mol) of the molar number of Ti in terms of atom to the total molar number of Ni, Co and Ti in terms of atom is lower than 4.0 at %.

Due to that the second region is formed from the border with the first region, in the depth direction, to the center of the particle, the lithium ion conduction in the second region is held, while the dissolving-out of the transition metals from the lithium nickel manganese cobalt composite oxide particle interior is suppressed and the cycle characteristics are improved.

In the present invention, with regard to the first region and the second region, by X-ray photoelectron spectroscopy (XPS), as the lithium nickel manganese cobalt composite oxide particle is etched with argon in the depth direction from the surface thereof, element peaks of Ni, Co and Ti are measured in the depth direction; and a region where the atomic & by mol of Ti to the total of Ni, Co and Ti is 4.0 at % or higher is judged to be the first region, and a region where the atomic % by mol of Ti to the total of Ni, Co and Ti becomes lower than 4.0 at % is judged to be the second region.

In the positive electrode active substance for a lithium secondary battery of the present invention, the atomic & by mol of Ti to the total of Ni, Co and Ti in the particle surface of the lithium nickel manganese cobalt composite oxide particle made to contain Ti as solid solution is preferably 6.0 at % or higher, and more preferably 6.5 to 95.0 at % or higher, still more preferably 7.0 to 50.0 at % or higher and further still more preferably 10.0 to 30.0 at % or higher. Due to that the atomic & by mol of Ti in the surface of the lithium nickel manganese cobalt composite oxide particle is in the above range, the dissolving-out of the transition metals from the lithium nickel manganese cobalt composite oxide particle interior is suppressed and the cycle characteristics are improved, while the lithium ion conduction is held. Here, the atomic % by mol of Ti to the total of Ni, Co and Ti in the particle surface is a value calculated by the following expression:

$$Atomic \% by mol of Ti to the total of Ni , Co and Ti = ( Ti / ( Ni + Co + Ti ) ) \times 100$$

wherein Ni, Co and Ti are molar numbers in terms of atom, based on an analysis value at 0 nm in the depth direction when by X-ray photoelectron spectroscopy (XPS), as the lithium nickel manganese cobalt composite oxide particle is etched with argon in the depth direction from the surface thereof, element peaks of Ni, Co and Ti are measured in the depth direction.

In the positive electrode active substance for a lithium secondary battery of the present invention, the content of Ti in the lithium nickel manganese cobalt composite oxide particle made to contain Ti as solid solution is, in terms of atom, with respect to the total amount (mol) of Ni, Mn, Co and M, preferably 0.01 to 5.00% by mol and especially preferably 0.02 to 4.50% by mol. Due to that the amount of Ti contained as solid solution is in the above range, the initial capacity and the cycle characteristics both can simultaneously be satisfied. Here, the content of Ti in the lithium nickel manganese cobalt composite oxide particle refers to a percentage of the total mol of Ti in terms of atom contained in the whole lithium nickel manganese cobalt composite oxide particle to the total amount (mol) of Ni, Mn, Co and M in terms of atom contained in the whole lithium nickel manganese cobalt composite oxide particle.

It is preferable, in that the dissolving-out of the transition metals from the lithium nickel manganese cobalt composite oxide particle interior is suppressed and the cycle characteristics are improved, that in the positive electrode active substance for a lithium secondary battery of the present invention, the ratio (A/B) of “the atomic % by mol (A) of Ti to the total of Ni, Co and Ti at 0 nm in the depth direction” of the lithium nickel manganese cobalt composite oxide particle made to contain Ti as solid solution to “the atomic & by mol (B) of Ti to the total of Ni, Co and Ti at 330 nm in the depth direction” thereof, is 10.0 or higher, and preferably 10.5 to 150.0, especially preferably 11.0 to 120.0 and more preferably 15.0 to 40.0.

The positive electrode active substance for a lithium secondary battery of the present invention is a particulate of the lithium nickel manganese cobalt composite oxide particle made to contain Ti as solid solution. The lithium nickel manganese cobalt composite oxide particle made to contain Ti as solid solution may be a single particle of monodispersed primary particles, or may be an aggregated particle forming a secondary particle formed by aggregation of primary particles.

The average particle diameter of the positive electrode active substance for a lithium secondary battery of the present invention is a particle diameter (D50) at 50% in terms of volume in a particle size distribution determined by a laser diffraction/scattering method, and is 0.50 to 30.0 μm, and preferably 1.0 to 25.0 μm and especially preferably 1.5 to 20.0 μm. Then, the BET specific surface area of the positive electrode active substance for a lithium secondary battery of the present invention is preferably 0.05 to 2.00 m²/g and especially preferably 0.15 to 1.00 m²/g. Due to that the average particle diameter and the BET specific surface area of the positive electrode active substance for a lithium secondary battery of the present invention are in the above ranges, the preparation and the coatability of a positive electrode mixture become easy, and further, an electrode high in the packing property can be obtained.

Then, the content of remaining alkali in the positive electrode active substance for a lithium secondary battery of the present invention is preferably 1.20% by mass or lower and especially preferably 1.00% by mass or lower. Due to that the content of remaining alkali in the positive electrode active substance for a lithium secondary battery of the present invention is in the above range, expansion and deterioration of a battery caused by gas generation caused by the remaining alkali can be suppressed.

In the present invention, the remaining alkali indicates an alkali component dissolving out in water when the positive electrode active substance for a lithium secondary battery of the present invention is stirred and dispersed in water at 25° C. Then, the amount of the remaining alkali is determined by weighing 5 g of the positive electrode active substance for a lithium secondary battery of the present invention and 100 g of pure water in a beaker, dispersing the positive electrode active substance at 25° C. for 5 min by a magnetic stirrer, then filtering the dispersion, and subjecting the obtained filtrate to neutralization titration to determine the amount as an amount of alkali present in the filtrate. Here, the amount of remaining alkali is a value in terms of lithium carbonate of the amount of lithium measured by titration.

A method for producing the positive electrode active substance for a lithium secondary battery of the present invention is not especially limited, but the positive electrode active substance for a lithium secondary battery of the present invention is suitably produced, for example, by a method for producing the positive electrode active substance for a lithium secondary battery of the present invention, described below.

The method for producing the positive electrode active substance for a lithium secondary battery of the present invention comprises: dry mixing a lithium nickel manganese cobalt composite oxide particle represented by the following general formula (1):

LiₓNi_{y}Mn_{z}CoₜMₚO₁₊ₓ (1)

wherein M denotes one or two or more metal elements selected from Mg, Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1, with a Ti-containing oxide to adhere the Ti-containing oxide on particle surface of the lithium nickel manganese cobalt composite oxide particle to thereby obtain a composite oxide particle having the Ti-containing oxide adhered thereon; and thereafter heat-treating the composite oxide particle having the Ti-containing oxide adhered thereon at 750° C. or higher and 1,000° C. or lower.

The lithium nickel manganese cobalt composite oxide particle represented by the general formula (1) relevant to the method for producing the positive electrode active substance for a lithium secondary battery of the present invention is produced, for example, by carrying out a raw material mixing step of mixing a lithium source, a nickel source, a manganese source, a cobalt source and an M source to be added as required to prepare a raw material mixture, and then, a firing step of firing the obtained raw material mixture.

As the lithium source, the nickel source, the manganese source, the cobalt source, and the M source to be added as required relevant to the raw material mixing step, for example, hydroxides, oxides, carbonate salts, nitrate salts, sulfate salts, or organic acid salts of these are used. The average particle diameters of the lithium source, the nickel source, the manganese source, the cobalt source and the M source are, as average particle diameters measured by a laser/scattering method, 0.50 to 30.0 μm and preferably 1.0 to 25.0 μm.

The nickel source, the manganese source and the cobalt source relevant to the raw material mixing step may be a compound containing a nickel atom, a manganese atom and a cobalt atom. Examples of the compound containing a nickel atom, a manganese atom and a cobalt atom include composite oxides, composite hydroxides, composite oxyhydroxides and composite carbonate salts containing these atoms.

As a method of preparing the compound containing a nickel atom, a manganese atom and a cobalt atom, a well-known method is used. For example, in the case of a composite hydroxide, the preparation can be made by a coprecipitation method. Specifically, by mixing an aqueous solution containing nickel atoms, cobalt atoms and manganese atoms in predetermined amounts, an aqueous solution of a complexing agent, and an aqueous solution of an alkali, a composite hydroxide can be coprecipitated (see Japanese Patent Laid-Open No. 10-81521, Japanese Patent Laid-Open No. 10-81520, Japanese Patent Laid-Open No. 10-29820, Japanese Patent Laid-Open No. 2002-201028 and the like). Then, in the case of a composite carbonate salt, preparation methods include a method in which a solution (solution A) containing nickel ions, manganese ions and cobalt ions, and a solution (solution B) containing carbonate ions or hydrogencarbonate ions are added in a reaction vessel and a reaction is carried out (Japanese Patent Laid-Open No. 2009-179545), and a method in which a solution (solution A) containing a nickel salt, a manganese salt and a cobalt salt, and a solution (solution B) containing a metal carbonate salt or a metal hydrogencarbonate salt are added to a solution (solution C) containing the same anions as anions of the nickel salt, the manganese salt and the cobalt salt in the solution A, and the same anions as anions of the metal carbonate salt or the metal hydrogencarbonate salt in the solution B, and a reaction is carried out (Japanese Patent Laid-Open No. 2009-179544). Then, the compound containing a nickel atom, a manganese atom and a cobalt atom may be commercially available products.

The average particle diameter of the compound containing a nickel atom, a cobalt atom and a manganese atom is an average particle diameter determined by a laser/scattering method, and is 0.50 to 100 μm and preferably 1.0 to 80.0 μm.

In the production of the lithium nickel manganese cobalt composite oxide particle represented by the general formula (1), use of the composite hydroxide containing a nickel atom, a cobalt atom and a manganese atom as the nickel source, the manganese source and the cobalt source is preferable in that the reactivity becomes good.

In the raw material mixing step, with regard to the mixing proportion of the lithium source, and the nickel source, the manganese source, the cobalt source and the M source to be added as required, such a mixing proportion that the molar ratio (Li/(Ni+Mn+Co+M)) of the Li atom to the total molar number (Ni+Mn+Co+M) of the Ni atom, the Mn atom, the Co atom and the M atom in the nickel source, the manganese source and the cobalt source becomes 0.98 to 1.20 is preferable; and such a mixing proportion that the molar ratio becomes 1.00 to 1.10 is especially preferable, in that the discharge capacity becomes high.

Then, in the raw material mixing step, the mixing proportion of each raw material of the nickel source, the manganese source, the cobalt source and the M source to be added as required suffices when being regulated so as to make the atomic molar ratio of nickel, manganese, cobalt and M represented by the above general formula (1).

Then, the production histories of the lithium source, the manganese source, the cobalt source and the M source of the raw materials do not matter, but in order to produce a high-purity lithium nickel manganese cobalt composite oxide particle, it is preferable that the raw materials have as low contents of impurities as possible.

In the raw material mixing step, with regard to means of mixing the lithium source, the nickel source, the manganese source, the cobalt source and the M source to be added as required, although the mixing can be carried out by either one of wet mixing and dry mixing, dry mixing is preferable because the production is easy.

In the case of the dry mixing, it is preferable to carry out the mixing by a mechanical means so that the raw materials are homogeneously mixed. Examples of mixing apparatuses include high-speed mixer, Supermixer, Turbo Sphere mixer, Eirich mixer, Henschel mixer, Nauta mixer, ribbon blender, V-type mixer, conical blender, jet mill, Cosmomizer, paint shaker, bead mill, and ball mill. Here, in the laboratory level, a household mixer suffices.

In the case of the wet mixing, use of a media mill is preferable in that a slurry containing each raw material homogeneously dispersed can be prepared. Then, it is preferable, from the viewpoint that the raw material mixture excellent in the reactivity and containing each raw material homogeneously dispersed can be obtained, that the slurry after the mixing treatment is subjected to spray drying.

The firing step is a step of firing the raw material mixture obtained by the raw material mixing step to obtain the lithium nickel manganese cobalt composite oxide.

In the firing step, the firing temperature when the raw material mixture is fired to cause the raw materials to react is 600 to 1,000° C. and preferably 700 to 950° C. The reason therefor is because with the firing temperature being lower than 600° C., it is likely that the reaction is insufficient and unreacted lithium remains in a large amount; and on the other hand, with the temperature exceeding 1,000° C., it is likely that a lithium nickel manganese cobalt composite oxide once produced ends in being decomposed.

The firing time in the firing step is 3 hours or longer, and preferably 5 to 30 hours. The firing atmosphere in the firing step is an oxidative atmosphere such as air or oxygen gas.

Then, in the firing step, the firing may be carried out in a multi-stage manner. By carrying out the firing in a multi-stage manner, the lithium nickel manganese cobalt composite oxide particle better in the cycle characteristics can be obtained. In the case of carrying out the firing in a multi-stage manner, it is preferable that the firing is carried out in the range of 650 to 800° C. for 1 to 10 hours, and thereafter, the temperature is raised up to 800 to 950° C. so as to become a temperature higher than the 650 to 800° C., and at the temperature, the firing is carried out for 5 to 30 hours.

The lithium nickel manganese cobalt composite oxide thus obtained, as required, may be subjected to firing steps in multiple times.

Then, the lithium nickel manganese cobalt composite oxide in which the amount of remaining alkali is in the above range can be produced by, in the raw material mixing step in which the raw materials of the lithium source, the nickel source, the manganese source, the cobalt source and the M source to be added as required are mixed, mixing the raw materials in a mixing proportion of, as a molar ratio (Li/(Ni+Mn+Co+M)) of the Li atom to the total molar number (Ni+Mn+Co+M) of the Ni atom, the Mn atom, the Co atom and the M atom in the nickel source, the manganese source, the cobalt source and the M source, 0.98 to 1.20, and subjecting the resultant to a firing reaction at 700° C. or higher, preferably at 750 to 1,000° C. for 3 hours or longer, preferably 5 to 30 hours, to cause the lithium source, the nickel source, the manganese source, the cobalt source and the M source to be added as required to sufficiently react. In the present production method, by carrying out the firing in the above-mentioned multi-stage manner, the lithium nickel manganese cobalt composite oxide more reduced in the amount of remaining alkali can be produced.

Here, the remaining alkali of the positive electrode active substance for a lithium secondary battery of the present invention and the measurement method thereof are as described in the above-mentioned lithium nickel manganese cobalt composite oxide particle; and the remaining alkali indicates an alkali component dissolving out in water when the positive electrode active substance for a lithium secondary battery is stirred and dispersed in water at 25° C. Then, the amount of the remaining alkali is determined by weighing 5 g of the positive electrode active substance for a lithium secondary battery and 100 g of pure water in a beaker, dispersing the positive electrode active substance at 25° C. for 5 min by a magnetic stirrer, then filtering the dispersion, and subjecting an obtained filtrate to neutralization titration to determine the amount as an amount of alkali present in the filtrate. Here, the amount of remaining alkali is a value in terms of lithium carbonate of the amount of lithium measured by titration.

Examples of the Ti-containing oxide relevant to the method for producing the positive electrode active substance for a lithium secondary battery of the present invention include oxides of Ti such as TiO₂, Ti₂O₃, TiₙO₂ₙ₋₁ (n=3 to 9), and composite oxides containing Ti and one or two or more selected from Mg, Li, Ni, Mn, Co and M, and among these, an oxide of Ti, especially TiO₂ is preferable in that the effect of improving the cycle characteristics is high.

The average particle diameter of the Ti-containing oxide is a particle diameter (D50) at a volume accumulation of 50% determined by a laser diffraction/scattering method, and is 100 μm or smaller, and preferably 0.01 to 10.0 μm, which is preferable in that Ti can be made to be contained as solid solution efficiently in a shell layer of the particle surface of the lithium nickel manganese cobalt composite oxide particle.

Then, the Ti-containing oxide may be an aggregate forming a secondary particle formed by aggregation of primary particles. In the method for producing the positive electrode active substance for a lithium secondary battery of the present invention, since the lithium nickel manganese cobalt composite oxide particle and the Ti-containing oxide are dry mixed, the aggregated oxide containing Ti is finely disintegrated during the mixing; consequently, the microparticulated oxide containing Ti can be adhered on the particle surface of the lithium nickel manganese cobalt composite oxide particle.

In the case of using the aggregated oxide containing Ti, it is preferable, in that the Ti-containing oxide can efficiently be adhered on the particle surface of the lithium nickel manganese cobalt composite oxide particle, that the primary particle diameter of the Ti-containing oxide is, as an average particle diameter of primary particles determined from a scanning electron microscopic photograph, is 2.0 μm or smaller, and preferably 0.001 to 1.0 μm.

In the method for producing the positive electrode active substance for a lithium secondary battery of the present invention, it is preferable, in that the initial capacity and the cycle characteristics both can simultaneously be satisfied in preferable respective ranges, that the amount of the Ti-containing oxide to be mixed in the lithium nickel manganese cobalt composite oxide particle is, in terms of atom, with respect to the total amount (mol) of Ni, Mn, Co and M in the lithium nickel manganese cobalt composite oxide particle, as Ti, 0.01 to 5.00% by mol, and preferably 0.02 to 4.50% by mol.

Then, by dry mixing the lithium nickel manganese cobalt composite oxide particle represented by the general formula (1) and the Ti-containing oxide, the Ti-containing oxide is caused to be adhered on the particle surface of the lithium nickel manganese cobalt composite oxide particle represented by the general formula (1), and there can be obtained a composite oxide particle having the Ti-containing oxide adhered thereon, that is, the lithium nickel manganese cobalt composite oxide particle represented by the general formula (1) on which particle surface the Ti-containing oxide is adhered and distributed.

Examples of apparatuses used in the mixing treatment include a high-speed mixer, a Supermixer, a Turbo Sphere mixer, a Henschel mixer, a Nauta mixer, a ribbon blender and a V-type mixer. Here, the mixing treatment is not limited to mechanical means exemplified. Then, as a mixing apparatus on a laboratory level, a household mixer and a laboratory mill suffice.

In the method for producing the positive electrode active substance for a lithium secondary battery of the present invention, the composite oxide particle having the Ti-containing oxide adhered thereon is then heat treated at 750° C. or higher and 1,000° C. or lower, and preferably 755 to 975° C. and especially preferably 760 to 950° C. By carrying out this heat treatment, the lithium nickel manganese cobalt composite oxide particle containing the Ti-containing oxide as solid solution can be obtained which particle has, in the depth direction from the surface, a region (first region) where Ti is contained as solid solution in a predetermined atomic % by mol or higher, and a region (second region) where Ti is contained as solid solution in lower than the predetermined atomic & by mol, and comprises a lithium nickel manganese cobalt composite oxide represented by the general formula (1), exhibiting a single phase in X-ray diffractometry.

In the method for producing the positive electrode active substance for a lithium secondary battery of the present invention, the time of the heat treatment is not critical; and usually, when the time is 1 hour or longer, and preferably 2 to 10 hours, the positive electrode active substance for a lithium secondary battery exhibiting satisfactory performance can be obtained. The atmosphere of the heat treatment is preferably an oxidative atmosphere such as air or oxygen gas.

Then, in the method for producing the positive electrode active substance for a lithium secondary battery of the present invention, as described above, by heat treating the composite oxide particle having the Ti-containing oxide adhered thereon, the positive electrode active substance for a lithium secondary battery of the present invention can be obtained. Further, in the method for producing the positive electrode active substance for a lithium secondary battery of the present invention, after carrying out the heat treatment, as required, crushing, classification, granulation and the like may be carried out.

It is preferable, in that the capacity per volume becomes high, that the positive electrode active substance for a lithium secondary battery of the present invention is a mixture of large particles having an average particle diameter of 7.5 to 30.0 μm and small particles having an average particle diameter of 0.50 to 7.5 μm. The average particle diameter of the large particles is 7.5 to 30.0 μm, and preferably 8.0 to 25.0 μm and especially preferably 8.5 to 20.0 μm. The average particle diameter of the small particles is 0.5 to 7.5 μm, and preferably 1.0 to 7.0 μm and especially preferably 1.5 to 6.5 μm. Then, the mixing ratio of the large particles to the small particles is, in mass ratio, preferably from 7:13 to 19:1 and especially preferably from 1:1 to 9:1. In the mixture of the large particles and the small particles, the pressure density when the mixture is compression treated at 0.65 tonf/cm² is 2.7 g/cm³ or higher, and preferably 2.8 to 3.3 g/cm³ and more preferably 2.9 to 3.3 g/cm³, which are preferable in that the capacity per volume becomes high. Then, in the case where the positive electrode active substance for a lithium secondary battery of the present invention is a mixture of large particles and small particles, the mixture is obtained, for example, by separately producing the large particles having an average particle diameter of 7.5 to 30.0 μm, preferably 8.0 to 25.0 μm, especially preferably 8.5 to 20.0 μm, and the small particles having an average particle diameter of 0.5 to 7.5 μm, preferably 1.0 to 7.0 μm, especially preferably 1.5 to 6.5 μm, and then mixing the obtained large particles and small particles in a predetermined mixing ratio.

The lithium secondary battery of the present invention uses, as a positive electrode active substance, the positive electrode active substance for a lithium secondary battery of the present invention. The lithium secondary battery of the present invention is composed of a positive electrode, a negative electrode, a separator and a nonaqueous electrolyte containing a lithium salt.

The positive electrode relevant to the lithium secondary battery of the present invention is formed, for example, by applying and drying a positive electrode mixture on a positive electrode current collector. The positive electrode mixture is composed of the positive electrode active substance, a conductive agent, a binder and as required, a filler and the like to be added. In the lithium secondary battery of the present invention, the positive electrode has the positive electrode active substance for a lithium secondary battery of the present invention uniformly applied thereon. Hence, the lithium secondary battery of the present invention is high in the battery performance and excellent particularly in the cycle characteristics.

The content of the positive electrode active substance contained in the positive electrode mixture relevant to the lithium secondary battery of the present invention is preferably 70 to 100% by mass and especially preferably 90 to 98% by mass.

The positive electrode current collector relevant to the lithium secondary battery of the present invention is not especially limited as long as being an electron conductor causing no chemical change in a constituted battery, but examples thereof include stainless steels, nickel, aluminum, titanium, burned carbon, and aluminum and stainless steels whose surface has been surface treated with carbon, nickel, titanium or silver. These may be used by oxidizing the surface thereof, or may also be used by imparting roughness to the current collector surface by a surface treatment. Examples of the form of the current collector include foils, films, sheets, nets, punched materials, laths, porous materials, foams, and formed bodies of fibers or nonwoven fabrics. The thickness of the current collector is not especially limited, but is preferably made to be 1 to 500 μm.

The conductive agent relevant to the lithium secondary battery of the present invention is not especially limited as long as being an electron conducting material causing no chemical change in a constituted battery. Examples thereof include graphites such as natural graphite and artificial graphite, carbon blacks such as carbon black, acetylene black, Ketjen black, channel black, furnace black, lamp black and thermal black, conductive fibers such as carbon fibers and metal fibers, metal powders such as powders of carbon fluoride, aluminum, nickel or the like, conductive whiskers such as whiskers of zinc oxide, potassium titanate or the like, conductive metal oxides such as titanium oxide, and conductive materials such as polyphenylene derivatives; examples of the natural graphite include vein graphite, flake graphite and amorphous graphite. These can be used singly or in a combination of two or more. The blend ratio of the conductive agent is, in the positive electrode mixture, 1 to 50% by mass and preferably 2 to 30% by mass.

Examples of the binder relevant to the lithium secondary battery of the present invention include starch, polyvinylidene fluoride, polyvinyl alcohol, carboxymethylcellulose, hydroxypropylcellulose, regenerated cellulose, diacetylcellulose, polyvinylpyrrolidone, tetrafluoroethylene, polyethylene, polypropylene, ethylene-propylene diene terpolymer (EPDM), sulfonated EPDM, styrene butadiene rubber, fluororubber, tetrafluoroethylene-hexafluoroethylene copolymers, tetrafluoroethylene-hexafluoropropylene copolymers, tetrafluoroethylene-perfluoroalkyl vinyl ether copolymers, vinylidene fluoride-hexafluoropropylene copolymers, vinylidene fluoride-chlorotrifluoroethylene copolymers, ethylene-tetrafluoroethylene copolymers, polychlorotrifluoroethylene, vinylidene fluoride-pentafluoropropylene copolymers, propylene-tetrafluoroethylene copolymers, ethylene-chlorotrifluoroethylene copolymers, vinylidene fluoride-hexafluoropropylene-tetrafluoroethylene copolymers, vinylidene fluoride-perfluoromethyl vinyl ether-tetrafluoroethylene copolymers, ethylene-acrylic acid copolymers or (Na⁺) ion-crosslinked materials thereof, ethylene-methacrylic acid copolymers or (Na⁺) ion-crosslinked materials thereof, ethylene-methyl acrylate copolymers or (Na⁺) ion-crosslinked materials thereof, ethylene-methyl methacrylate copolymers or (Na⁺) ion-crosslinked materials thereof, polysaccharides of polyethylene oxide or the like, thermoplastic resins, and polymers having rubber elasticity; and these can be used singly or in a combination of two or more. Here, when a compound is used which contains a functional group reactive with lithium, like polysaccharides, it is preferable that a compound having, for example, an isocyanate group is added to deactivate the functional group. The blend ratio of the binder is, in the positive electrode mixture, 1 to 50% by mass and preferably 5 to 15% by mass.

The filler relevant to the lithium secondary battery of the present invention is a material to suppress the volume expansion and the like of the electrode in the positive electrode mixture, and is added as required. As the filler, any filler can be used as long as being a fibrous material causing no chemical change in a constituted battery, but fibers, for example, fibers of olefinic polymers such as polypropylene and polyethylene, glass, and carbon are used. The amount of the filler to be added is not especially limited, but is preferably 0 to 30% by mass in the positive electrode mixture.

The negative electrode relevant to the lithium secondary battery of the present invention is formed by applying and drying a negative electrode material on a negative electrode current collector. The negative electrode current collector relevant to the lithium secondary battery of the present invention is not especially limited as long as being an electron conductor causing no chemical change in a constituted battery, but examples thereof include stainless steels, nickel, copper, titanium, aluminum, burned carbon, and copper and stainless steels whose surface has been surface treated with carbon, nickel, titanium or silver, and aluminum-cadmium alloys. These may be used by oxidizing the surface thereof, or may also be used by imparting roughness to the current collector surface by a surface treatment. Examples of the form of the current collector include foils, films, sheets, nets, punched materials, laths, porous materials, foams, and formed bodies of fibers or nonwoven fabrics. The thickness of the current collector is not especially limited, but is preferably made to be 1 to 500 μm.

The negative electrode material relevant to the lithium secondary battery of the present invention is not especially limited, but examples thereof include carbonaceous materials, metal composite oxides, lithium metal, lithium alloys, silicon-based alloys, tin-based alloys, metal oxides, conductive polymers, chalcogen compounds, Li—Co—Ni-based alloys, Li₄Ti₅O₁₂, lithium niobate, and silicon oxide (SiOₓ: 0.5≤x≤1.6). Examples of the carbonaceous materials include non-graphitizable carbon materials and graphite-based carbon materials. Examples of the metal composite oxides include compounds such as Snₚ(M¹)₁₋ₚ(M²)_{q}Oᵣ (wherein M¹ is one or more elements selected from Mn, Fe, Pb and Ge; M² is one or more elements selected from Al, B, P, Si, periodic table group 1, group 2 and group 3 elements and halogen elements; and 0<p≤1, 1≤q≤3 and 1≤r≤8), LiₜFe₂O₃ (0≤t≤1) and LiₜWO₂ (0≤t≤1). The metal oxides include GeO, GeO₂, SnO, SnO₂, PbO, PbO₂, Pb₂O₃, Pb₃O₄, Sb₂O₃, Sb₂O₄, Sb₂O₅, Bi₂O₃, Bi₂O₄ and Bi₂O₅. The conductive polymers include polyacetylene and poly-p-phenylene.

As the separator relevant to the lithium secondary battery of the present invention, there is used an insulating thin film having a high ion permeability and having a predetermined mechanical strength. There is used a sheet or a nonwoven fabric composed of an olefinic polymer such as polypropylene, or glass fibers, or polyethylene, or the like from the viewpoint of the organic solvent resistance and the hydrophobicity. The pore diameter of the separator suffices if being in the range useful as pores for batteries, and is, for example, 0.01 to 10 μm. The thickness of the separator suffices if being in the range for usual batteries, and is, for example, 5 to 300 μm. Then, in the case where a solid electrolyte such as a polymer is used as an electrolyte described later, the solid electrolyte may serve also as a separator.

The nonaqueous electrolyte containing a lithium salt relevant to the lithium secondary battery of the present invention is composed of a nonaqueous electrolyte and the lithium salt. As the nonaqueous electrolyte relevant to the present invention, a nonaqueous electrolyte solution, an organic solid electrolyte or an inorganic solid electrolyte is used. Examples of the nonaqueous electrolyte solution include one of or mixed solvents of two or more of aprotic organic solvents such as N-methyl-2-pyrroridinone, propylene carbonate, ethylene carbonate, butylene carbonate, dimethyl carbonate, diethyl carbonate, γ-butyrolactone, 1,2-dimethoxyethane, tetrahydroxyfuran, 2-methyltetrahydrofuran, dimethyl sulfoxide, 1,3-dioxolane, formamide, dimethylformamide, dioxolane, acetonitrile, nitromethane, methyl formate, methyl acetate, phosphate triesters, trimetoxymethane, dioxolane derivatives, sulfolane, methyl sulfolane, 3-methyl-2-oxazolidinone, 1,3-dimethyl-2-imidazolidinone, propylene carbonate derivatives, tetrahydrofuran derivatives, diethyl ether, 1,3-propanesultone, methyl propionate and ethyl propionate.

Examples of the organic solid electrolyte relevant to the lithium secondary battery of the present invention include: polymers containing ionic dissociation groups of polyethylene derivatives, polyethylene oxide derivatives or polymers containing these, polypropylene oxide derivatives or polymers containing these, phosphate ester polymers, polyphosphazene, polyaziridine, polyethylene sulfide, polyvinyl alcohol, polyvinylidene fluoride, polyhexafluoropropylene, and the like; and mixtures of the polymer containing ionic dissociation groups and the above-mentioned nonaqueous electrolyte solution.

As the inorganic solid electrolyte relevant to the lithium secondary battery of the present invention, there can be used a nitride, a halide, an oxygen acid salt, a sulfide or the like of Li; and examples thereof include Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, P₂S₅, Li₂S or Li₂S—P₂S₅, Li₂S—SiS₂, Li₂S—GeS₂, Li₂S—Ga₂S₃, Li₂S—B₂S₃, Li₂S—P₂S₅—X, Li₂S—SiS₂—X, Li₂S—GeS₂—X, Li₂S—Ga₂S₃—X, Li₂S—B₂S₃—X, (wherein X is at least one or more selected from LiI, B₂S₃ and Al₂S₃).

Further when the inorganic solid electrolyte is an amorphous material (glass), the inorganic solid electrolyte can be made to contain a compound containing oxygen, such as Lithium phosphate (Li₃PO₄), lithium oxide (Li₂O), lithium sulfate (Li₂SO₄), phosphorus oxide (P₂O₅) or lithium borate (Li₃BO₃), or a compound containing nitrogen, such as Li₃PO₄₋ᵤN_{2u/3} (u is 0<u<4), Li₄SiO₄₋ᵤN_{2u/3} (u is 0<u<4), Li₄GeO₄₋ᵤN_{2u/3} (u is 0<u<4) or Li₃BO₃₋ᵤN_{2u/3} (u is 0<u<3). The addition of the compound containing oxygen or the compound containing nitrogen leads to expansion of interstices in an amorphous skeleton formed, whereby the hindrance to lithium ion migration can be reduced, and further the ionic conductivity can be improved.

As the lithium salt relevant to the lithium secondary battery of the present invention, those dissolving in the above nonaqueous electrolyte are used, and examples thereof include one of or mixed salts of two or more of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiB₁₀Cl₁₀, LiAlCl₄, CH₃SO₃Li, CF₃SO₃Li, (CF₃SO₂)2NLi, chloroborane lithium, lithium lower aliphatic carboxylates, lithium tetraphenylborate, and imides.

Then, to the nonaqueous electrolyte, compounds indicated below can be added for the purpose of improving charge and discharge characteristics and the flame retardancy. Examples thereof include pyridine, triethyl phosphite, triethanolamine, cyclic ethers, ethylenediamine, n-glyme, triamide hexaphosphate, nitrobenzene derivatives, sulfur, quinoneimine dyes, N-substituted oxazolidinone, N, N-substituted imidazolidine, ethylene glycol dialkyl ethers, ammonium salts, polyethylene glycol, pyrrole, 2-methoxyethanol, aluminum trichloride, monomers of conductive polymeric electrode active substances, triethylene phosphonamide, trialkyl phosphines, morpholine, aryl compounds having a carbonyl group, hexamethylphosphoric triamide, 4-alkylmorpholines, dicyclic tertiary amines, oils, phosphonium salts, tertiary sulfonium salts, phosphazene and carbonate esters. Further in order to make the electrolyte solution to be nonflammable, the electrolyte solution can be made to contain a halogen-containing solvent, for example, carbon tetrachloride or ethylene trifluoride. Further in order to make the electrolyte solution to have suitability for high-temperature storage, the electrolyte solution can be made to contain carbon dioxide gas.

The lithium secondary battery of the present invention is a lithium secondary battery little in the deterioration of the cycle characteristics and high in the energy density retention rate particularly even in repetition of charge and discharge; and the shape of the battery may be any of a button shape, a sheet shape, a cylinder shape, a square shape, a coin shape and the like.

Applications of the lithium secondary battery of the present invention are not especially limited, but examples thereof include electronic devices such as notebook personal computers, laptop personal computers, pocket word processors, mobile phones, cordless slave units, portable CD players, radios, liquid crystal televisions, backup power sources, electric shavers, memory cards and video movies, and consumer electronic devices for automobiles, motorized vehicles, drones, game machines, electric power tools and the like.

### EXAMPLES

Hereinafter, the present invention will be described in more detail by way of Examples, but the present invention is not any more limited to these Examples.

### <Preparation of Lithium Nickel Manganese Cobalt Composite Oxide Particle (LNMC) Samples>

### <LNMC Sample 1>

Lithium carbonate (average particle diameter: 5.7 μm) and a nickel manganese cobalt composite hydroxide (Ni:Mn:Co=6:2:2 (in molar ratio), average particle diameter: 9.8 μm) were weighed, and fully mixed by a household mixer to obtain a raw material mixture having a molar ratio of Li/(Ni+Mn+Co) of 1.01. Here, the nickel manganese cobalt composite hydroxide used was a commercially available one.

Then, the obtained raw material mixture was fired in an alumina-made bowl at 700° C. for 2 hours, then at 850° C. for 10 hours, in the air atmosphere. After the firing, the fired product was crushed and classified. The obtained fired product was measured by XRD, and it was confirmed that the product was a single-phase lithium nickel manganese cobalt composite oxide. Then, the obtained fired product was a secondarily aggregated spherical lithium nickel manganese cobalt composite oxide particle (LiNi_{0.6}Mn_{0.2}Co_{0.2}O₂) having an average particle diameter of 10.2 μm, and a BET specific surface area of 0.21 m²/g.

### <LNMC Sample 2>

Lithium carbonate (average particle diameter: 5.7 μm) and a nickel manganese cobalt composite hydroxide (Ni:Mn:Co=6:2:2 (in molar ratio), average particle diameter: 3.7 μm) were weighed, and fully mixed by a household mixer to obtain a raw material mixture having a molar ratio of Li/(Ni+Mn+Co) of 1.01. Here, the nickel manganese cobalt composite hydroxide used was a commercially available one.

Then, the obtained raw material mixture was fired in an alumina-made bowl at 700° C. for 2 hours, then at 850° C. for 10 hours, in the air atmosphere. After the firing, the fired product was crushed and classified. The obtained fired product was measured by XRD, and it was confirmed that the product was a single-phase lithium nickel manganese cobalt composite oxide. Then, the obtained fired product was a secondarily aggregated spherical lithium nickel manganese cobalt composite oxide particle (LiNi_{0.6}Mn_{0.2}Co_{0.2}O₂) having an average particle diameter of 5.4 μm, and a BET specific surface area of 0.69 m²/g.

Various physical properties of the lithium nickel manganese cobalt composite oxide samples (LNMC samples) obtained in the above are shown in Table 1.

Here, the average particle diameter, the amount of remaining alkali and the pressure density of the LNMC samples were measured as follows.

### <Average Particle Diameter>

The average particle diameter was determined by a laser diffraction/scattering method.

### <Measurement of the Amount of Remaining Alkali>

5 g of a sample and 100 g of ultrapure water were weighed out in a beaker, and dispersed by using a magnetic stirrer at 25° C. for 5 min. Then, the dispersion was filtered, and 70 ml of the filtrate was titrated with 0.1N-HCl by an automatic titration device (type: COMTITE-2500) and the amount of remaining alkali (a value in terms of lithium carbonate of an amount of lithium measured) present in the sample was calculated.

### <Pressure Density>

2.25 g of a sample was weighed out and charged in a double punch molding vessel of 1.5 cm in diameter, and the height of the compressed sample was measured in the state that a pressure of 65 tonf/cm² is applied by using a press machine; and the pressure density of the sample was calculated from an apparent volume of the compressed sample calculated from the height and a mass of the weighed sample.

TABLE 1

| | | | BET | | | |
|---|---|---|---|---|---|---|
| | | Average | Specific | | | |
| | Ratio of | Particle | Surface | Amount of | Pressure | |
| LNMC | Li/(Ni + Mn + Co) | Diameter | Area | Remaining Alkali | Density | State of |
| Sample | Charged | (μm) | (m²/g) | (% by mass) | (g/cm³) | Particle |
| Sample | 1.01 | 10.2 | 0.21 | 0.48 | 2.8 | Secondarily |
| 1 | | | | | | aggregated |
| | | | | | | spherical |
| | | | | | | particle |
| Sample | 1.01 | 5.4 | 0.69 | 0.42 | 2.4 | Secondarily |
| 2 | | | | | | aggregated |
| | | | | | | spherical |
| | | | | | | particle |

### Example 1

29.9 g of the LNMC sample 1 was collected, and thereto, 0.0618 g of titanium oxide (TiO₂) was added, and fully mixed by a laboratory mill to obtain a composite oxide particle having TiO₂ adhered thereon. Then, the obtained composite oxide particle having TiO₂ adhered thereon was fired at 800° C. for 5 hours to be subjected to the heat treatment, and thereafter, crushed and classified to obtain a positive electrode active substance sample made to contain Ti as solid solution in 0.25% by mol with respect to the total amount of Ni, Mn and Co in the LNMC sample 1. The average particle diameter (D50) of the obtained positive electrode active substance was 10.2 μm, and the BET specific surface area thereof was 0.21 m²/g.

Then, the amount of remaining alkali and the pressure density were measured by the same method as in the LNMC samples. The results are shown in Table 2.

The titanium oxide used was an aggregate composed of a secondary particle of aggregated primary particles. The particle diameter (D50) at 50% in terms of volume determined by a laser diffraction/scattering method was 0.38 μm; and the average particle diameter of the primary particles determined from a SEM photograph was 0.035 μm.

Here, the average particle diameter of primary particles was determined by arbitrarily sampling 30 particles from a scanning electron microscopic observation, measuring the breadth and the length of each particle and calculating ½ of the sum of both thereof and determining the average value of the 30 particles as the average particle diameter.

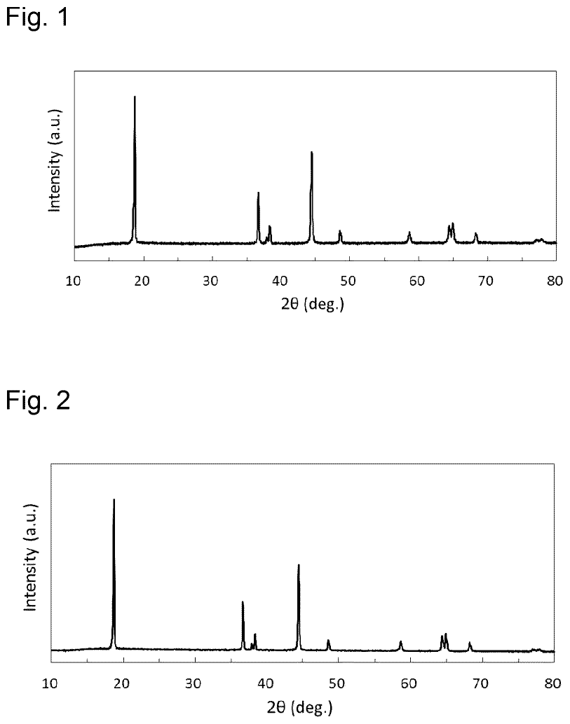

Then, the obtained positive electrode active substance sample was subjected to X-ray diffractometry using the Cu—Kα line as the line source. Neither diffraction peak caused by TiO₂ nor diffraction peaks of heterophases of LiTiO₂, Li₂TiO₃ and the like were observed; and it was confirmed that the positive electrode active substance sample was a single-phase lithium nickel manganese cobalt composite oxide particle. Then, an X-ray diffraction diagram of the positive electrode active substance sample is shown in FIG. 1.

The particle surface of the positive electrode active substance sample was checked by element mapping analysis of Ti using SEM-EDX (a field emission-scanning electron microscope, SU-8220, manufactured by Hitachi High-Technologies Corp., and an energy dispersive X-ray spectrometer, XFlash5060FlatQUAD, manufactured by Bruker Corp.) at an enlarging magnification of 20,000 times. Ti was uniformly distributed similarly to Co, Ni and Mn.

From the results of the X-ray diffractometry, the element mapping analysis of Ti, and the X-ray photoelectron spectroscopy (XPS) described later, it was confirmed that Ti was present as solid solution in the particle interior of the positive electrode active substance sample.

### Example 2

29.9 g of the LNMC sample 2 was collected, and thereto, 0.144 g of titanium oxide (TiO₂) was added, and fully mixed by a laboratory mill to obtain a TiO₂-adhered composite oxide particle. Then, the obtained TiO₂-adhered composite oxide particle was fired at 800° C. for 5 hours to be subjected to the heat treatment, and thereafter, crushed and classified to obtain a positive electrode active substance sample made to contain Ti in 0.58% by mol with respect to the total amount of Ni, Mn and Co in the LNMC sample 2. The average particle diameter (D50) of the obtained positive electrode active substance was 4.0 μm, and the BET specific surface area thereof was 0.69 m²/g.

Then, the amount of remaining alkali and the pressure density were measured by the same method as in the LNMC samples. The results are shown in Table 2.

Then, the obtained positive electrode active substance sample was subjected to X-ray diffractometry using the Cu—Kα line as the line source. Neither diffraction peak caused by TiO₂ nor diffraction peaks of heterophases of LiTiO₂, Li₂TiO₃ and the like were observed; and it was confirmed that the positive electrode active substance sample was a single-phase lithium nickel manganese cobalt composite oxide particle. Then, an X-ray diffraction diagram of the positive electrode active substance sample is shown in FIG. 2.

The particle surface of the positive electrode active substance sample was checked by element mapping analysis of Ti using SEM-EDX (a field emission-scanning electron microscope, SU-8220, manufactured by Hitachi High-Technologies Corp., and an energy dispersive X-ray spectrometer, XFlash5060FlatQUAD, manufactured by Bruker Corp.). Ti was uniformly distributed similarly to Co, Ni and Mn.

From the results of the X-ray diffractometry, the element mapping analysis of Ti (FIG. 6), and the X-ray photoelectron spectroscopy (XPS) described later, it was confirmed that Ti was present as solid solution in the particle interior of the positive electrode active substance sample.

TABLE 2

| | | Heat Treatment | Amount of Ti | Amount of | Pressure |
|---|---|---|---|---|---|
| | LNMC | Temperature | Charged¹⁾ | Remaining Alkali | Density |
| | Sample | (° C.) | (% by mol) | (% by mass) | (g/cm³) |
| Example | Sample 1 | 800 | 0.25 | 0.41 | 2.7 |
| 1 | | | | | |
| Example | Sample 2 | 800 | 0.58 | 0.40 | 2.4 |
| 2 | | | | | |

1) Respective amounts of Ti charged of Example 1 and Example 2 were calculated as percentages of amounts of Ti in terms of atom to the total amount of Ni, Mn, Co and M in terms of atom in LNMC samples determined from amounts of TiO₂ charged.

### Comparative Example 1

Lithium carbonate (average particle diameter: 5.7 μm), a nickel manganese cobalt composite hydroxide (Ni:Mn:Co=6:2:2 (in molar ratio), average particle diameter: 9.8 μm), and titanium oxide (TiO₂) were weighed, and fully mixed by a household mixer to obtain a raw material mixture having a molar ratio of Li/(Ni+Mn+Co) of 1.01, and having Ti adhered in 0.25% by mol with respect to the total amount of Ni, Mn and Co in the nickel manganese cobalt composite hydroxide. Here, the nickel manganese cobalt composite hydroxide used was a commercially available one.

Then, the obtained raw material mixture was fired in an alumina-made bowl at 700° C. for 2 hours, then at 850° C. for 10 hours, in the air atmosphere. After the firing, the fired product was crushed and classified. The resultant had an average particle diameter of 10.4 μm and a BET specific surface area of 0.31 m²/g.

Then, the amount of remaining alkali and the pressure density were measured by the same method as in the LNMC samples. The results are shown in Table 3.

Then, the obtained positive electrode active substance sample was subjected to X-ray diffractometry using the Cu—Kα line as the line source. Neither diffraction peak caused by TiO₂ nor diffraction peaks of heterophases of LiTiO₂, Li₂TiO₃ and the like were observed.

### Comparative Example 2

Lithium carbonate (average particle diameter: 5.7 μm), a nickel manganese cobalt composite hydroxide (Ni:Mn:Co=6:2:2 (in molar ratio), average particle diameter: 3.7 μm), and titanium oxide (TiO₂) were weighed, and fully mixed by a household mixer to obtain a raw material mixture having a molar ratio of Li/(Ni+Mn+Co) of 1.01, and having Ti adhered in 0.58% by mol with respect to the total amount of Ni, Mn and Co in the nickel manganese cobalt composite hydroxide. Here, the nickel manganese cobalt composite hydroxide used was a commercially available one.

Then, the obtained raw material mixture was fired in an alumina-made bowl at 700° C. for 2 hours, then at 850° C. for 10 hours, in the air atmosphere. After the firing, the fired product was crushed and classified. The resultant had an average particle diameter of 4.0 μm and a BET specific surface area of 0.70 m²/g.

Then, the amount of remaining alkali and the pressure density were measured by the same method as in the LNMC samples. The results are shown in Table 3.

Then, the obtained positive electrode active substance sample was subjected to X-ray diffractometry using the Cu—Kα line as the line source. Neither diffraction peak caused by TiO₂ nor diffraction peaks of heterophases of LiTiO₂, Li₂TiO₃ and the like were observed.

TABLE 3

| | | Average | | | |
|---|---|---|---|---|---|
| | Ratio of | Particle | Amount of Ti | Amount of | Pressure |
| | Li/(Ni + Mn + Co) | Diameter | Charged¹⁾ | Remaining Alkali | Density |
| | Charged | (μm) | (% by mol) | (% by mass) | (g/cm³) |
| Comparative | 1.01 | 10.4 | 0.25 | 0.52 | 2.8 |
| Example 1 | | | | | |
| Comparative | 1.01 | 4.0 | 0.58 | 0.59 | 2.5 |
| Example 2 | | | | | |

1) Respective amounts of Ti charged of Comparative Example 1 and Comparative Example 2 were calculated as percentages of amounts of Ti in terms of atom to the total amount of Ni, Mn, Co and M in terms of atom in LNMC samples determined from amounts of TiO₂ charged.

### <State of the Ti Distribution>

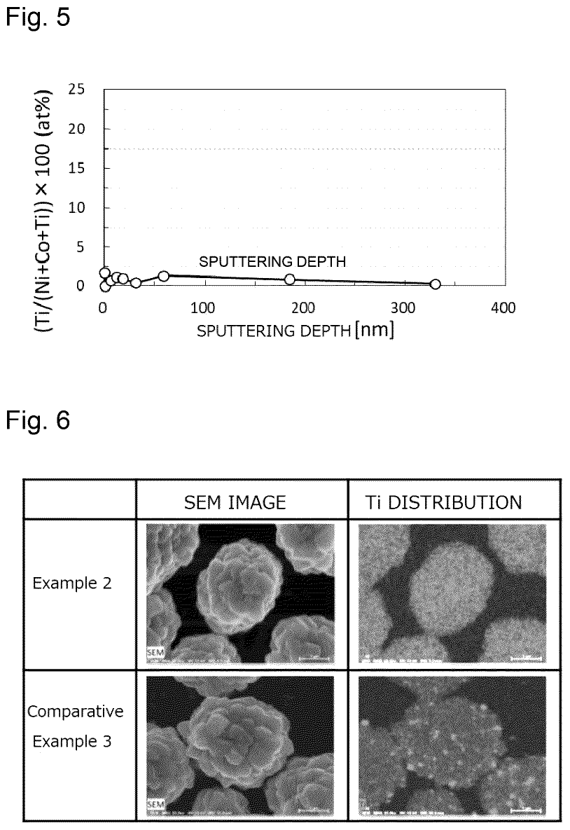

As the positive electrode active substance sample obtained in Examples was etched with argon in the depth direction from the surface thereof by an X-ray photoelectron spectrometer (XPS) (device name: QuanteraSXM, manufactured by ULVAC-PHI, Inc.), the Ti peak, the Ni peak and the Co peak were measured in the depth direction; and the atomic % by mol ((Ti/(Ni+Co+Ti))×100) of Ti to the total of Ni, Co and Ti in the particle surface and the particle interior of the positive electrode active substance sample, was determined, and then, the atomic % by mol of Ti to the total of Ni, Co and Ti in the particle surface, the depth of the first region formed, and the ratio (A/B) of “the atomic % by mol (A) of Ti to the total of Ni, Co and Ti at 0 nm in the depth direction” to “the atomic & by mol (B) of Ti to the total of Ni, Co and Ti at 330 nm in the depth direction”, were determined. The results are shown in Table 4. FIG. 4 and FIG. 5 show variations in “the atomic % by mol ((Ti/(Ni+Co+Ti))×100) of Ti to the total of Ni, Co and Ti” in the depth direction of the positive electrode active substances obtained in Example 1 and Comparative Example 1, respectively.

Then, the etching condition was as follows.
X-ray source: (monochrome AlKα)
Ion species: Ar+
Output: 25 W
   Accelerating voltage: 15 kV
Etching rate: 2.2 to 2.4 nm/min (in terms of SiO₂)

### Orbit of Element Measured

Co: 2P_{3/2}
Ni: 2P_{3/2}
Ti: 2P

TABLE 4

| | Particle Surface of | | | |
|---|---|---|---|---|
| | Positive Electrode | | | |
| | Active Substance | | | |
| | Sample | Particle Interior of Positive Electrode Active | | |
| | Atomic % by mol of Ti | Substance Sample | | |
| | (at %)¹⁾ | First Region²⁾ | Second Region²⁾ | A/B³⁾ |
| Example 1 | 14.9 | from particle surface | from 31 nm in the | 29.0 |
| | | to 31 nm in the | depth direction to | |
| | | depth direction | the particle center | |
| Example 2 | 24.4 | from particle surface | from 18 nm in the | 28.8 |
| | | to 18 nm in the | depth direction to | |
| | | depth direction | the particle center | |
| Comparative | 1.7 | not present | — | 6.6 |
| Example 1 | | | | |
| Comparative | 2.2 | not present | — | 4.3 |
| Example 2 | | | | |

1) The atomic % by mol of Ti in the particle surface was a value of “(Ti/(Ni+Co+Ti))×100” calculated from a measurement value at 0 nm in the depth direction in X-ray photoelectron spectroscopy (XPS).

2) With regard to the “first region”, a sample was subjected to X-ray photoelectron spectroscopy (XPS), and as the sample was etched with argon in the depth direction from the surface thereof, element peaks of Ni, Co and Ti were measured in the depth direction; and a region where the atomic % by mol ((Ti/(Ni+Co+Ti))×100) of Ti to the total of Ni, Co and Ti was 4.0 at % or higher was judged to be the first region; and with regard to the second region, a region where the atomic $ by mol ((Ti/(Ni+Co+Ti))×100) of Ti to the total of Ni, Co and Ti was lower than 4.0 at& was judged to be the second region.

3) The “A/B” indicates the ratio (A/B) of “the atomic % by mol ((Ti/(Ni+Co+Ti))×100) (A) of Ti to the total of Ni, Co and Ti at 0 nm in the depth direction” to “the atomic % by mol ((Ti/(Ni+Co+Ti))×100 (B) of Ti to the total of Ni, Co and Ti at 330 nm in the depth direction”.

### Comparative Example 3

A positive electrode active substance sample having Ti adhered in 0.58% by mol with respect to the total amount of Ni, Mn and Co in the LNMC sample 2 was obtained as in Example 2, except for carrying out heat treatment of firing an obtained TiO₂-adhered composite oxide particle at 600° C. for 5 hours instead of carrying out heat treatment of firing the obtained composite oxide particle having TiO₂ adhered thereon at 800° C. for 5 hours. The average particle diameter (D50) of the obtained positive electrode active substance was 3.9 μm, and the BET specific surface area thereof was 0.88 m²/g.

Then, the amount of remaining alkali and the pressure density were measured by the same method as in the LNMC samples. The results are shown in Table 5.

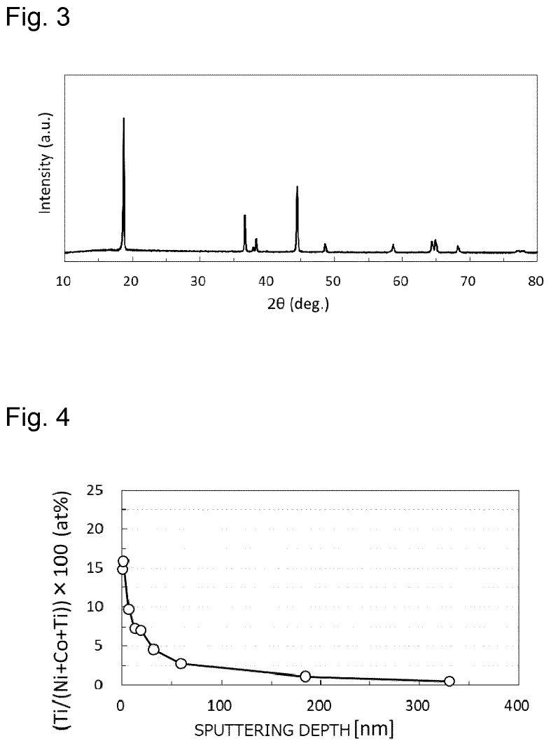

Then, the obtained positive electrode active substance sample was subjected to X-ray diffractometry using the Cu—Kα line as the line source. No diffraction peaks other than those of the lithium nickel manganese cobalt composite oxide were confirmed. Then, an X-ray diffraction diagram of the positive electrode active substance sample is shown in FIG. 3. Here, the reason why no diffraction peaks other than those of the lithium nickel manganese cobalt composite oxide were confirmed is conceivably because the amount of the oxide of Ti was small.

Then, the particle surface of the positive electrode active substance sample was checked by element mapping analysis of Ti using SEM-EDX (a field emission-scanning electron microscope, SU-8220, manufactured by Hitachi High-Technologies Corp., and an energy dispersive X-ray spectrometer, XFlash5060FlatQUAD, manufactured by Bruker Corp.) at an enlarging magnification of 20,000 times. Ti was maldistributed and unevenly distributed.

From the result of the element mapping analysis of Ti, it was confirmed that Ti was not contained as solid solution in the particle interior of the positive electrode active substance sample, and was present on the particle surface as an oxide of Ti (FIG. 6).

### Comparative Example 4

29.9 g of a LiCoO₂ sample (LCO sample) was collected, and 0.0612 g of titanium oxide (TiO₂) was added thereto, and fully mixed by a laboratory mill to obtain an LCO particle having TiO₂ adhered thereon. Then, the obtained LCO particle having TiO₂ adhered thereon was fired at 900° C. for 5 hours to be subjected to the heat treatment, and thereafter, crushed and classified to obtain a positive electrode active substance sample made to contain Ti as solid solution in 0.25% by mol with respect to the amount of Co in the LCO sample. The average particle diameter (D50) of the obtained positive electrode active substance was 8.3 μm, and the BET specific surface area thereof was 0.37 m²/g.

Then, the amount of remaining alkali and the pressure density were measured by the same method as in the LNMC samples. The results are shown in Table 5.

Then, the obtained positive electrode active substance sample was subjected to X-ray diffractometry using the Cu—Kα line as the line source. Neither diffraction peak caused by TiO₂ nor diffraction peaks of heterophases of LiTiO₂, Li₂TiO₃ and the like were observed; and it was confirmed that the positive electrode active substance sample was a single-phase lithium cobalt composite oxide particle.

TABLE 5

| | | Heat Treatment | Amount of Ti | Amount of | Pressure |
|---|---|---|---|---|---|
| | LNMC | Temperature | Charged¹⁾ | Remaining Alkali | Density |
| | Sample | (° C.) | (% by mol) | (% by mass) | (g/cm³) |
| Comparative | Sample 2 | 600 | 0.58 | 0.52 | 2.4 |
| Example 3 | | | | | |
| Comparative | LCO Sample | 900 | 0.25 | 0.03 | — |
| Example 4 | | | | | |

1) The amount of Ti charged of Comparative Example 3 was calculated as a percentage of the amount of Ti in terms of atom to the total amount of Ni, Mn, Co and M in terms of atom in the LNMC sample determined from the amount of TiO₂ charged.

Then, the amount of Ti charged of Comparative Example 4 was calculated as a percentage of the amount of Ti in terms of atom to the amount of Co in terms of atom in the LCO sample determined from the amount of TiO₂ charged.

Note) “-” in the Table indicates being not measured.

Battery performance tests were carried out as follows.

### <Fabrication of Lithium Secondary Batteries 1>

95% by mass of the positive electrode active substance sample obtained in Examples 1 and 2 and Comparative Examples 1 to 4 each, 2.5% by mass of a graphite powder and 2.5% by mass of a polyvinylidene fluoride were mixed to make a positive electrode mixture, and the mixture was dispersed in N-methyl-2-pyrrolidinone to thereby prepare a kneaded paste. The kneaded paste was applied on an aluminum foil, thereafter dried and pressed and punched out into a disc of 15 mm in diameter to thereby obtain a positive electrode plate.

By using the positive electrode plate, each member of a separator, a negative electrode, a positive electrode, current collectors, mounting metal fittings, external terminals, an electrolyte solution and the like was used to thereby fabricate a coin-type lithium secondary battery. Among these, the negative electrode used was a metal lithium foil, and the electrolyte solution used was one in which 1 mol of LiPF₆ was dissolved in 1 L of a mixed solution of ethylene carbonate and methyl ethyl carbonate in 1:1.

Then, performance evaluations of the obtained lithium secondary batteries were made. The results are shown in Table 6 and Table 7. Then, lithium secondary batteries were fabricated by the same method using, as their positive electrode active substance, the LNMC sample 1 (Comparative Example 5) and the LNMC sample 2 (Comparative Example 6), respectively, and the same evaluations were made. The results are shown in Table 6 and Table 7.

### <Performance Evaluations of the Batteries 1>

The fabricated coin-type lithium secondary batteries were each operated at room temperature under the following test conditions and the following battery performance was evaluated.

### (1) Test Condition for Evaluation of Cycle Characteristics

First, on the battery, there was carried out constant current·constant voltage charge (CCCV charge) in which charge at 0.5C up to 4.3 V was carried out over 2 hours and the voltage of 4.3 V was held for 3 hours. Thereafter, constant current discharge (CC discharge) at 0.2C or 1.0C down to 2.7 V was carried out. The operation of these charge and discharge was taken as one cycle, a total of 30 cycles were performed, and the discharge capacity was measured at every one cycle. Among these cycles, for the first cycle, the second cycle, the tenth cycle, the twentieth cycle, and the thirtieth cycle, the CC discharge was carried out at 0.2C; and for the other cycles, at 1.0C.

### (2) First-Cycle Charge Capacity and First-Cycle Discharge Capacity (Per Active Substance Weight)

The charge capacity and the discharge capacity of the first cycle in the evaluation of the cycle characteristics were taken as a first-cycle charge capacity and a first-cycle discharge capacity, respectively.

(3) 30th-Cycle Discharge Capacity (Per Active Substance Weight)

The discharge capacity of the thirtieth cycle in the evaluation of the cycle characteristics was taken as a 30th-cycle discharge capacity.

### (4) Capacity Retention Rate

The capacity retention rate was calculated by the following expression from the respective discharge capacities (per active substance weight) of the first cycle and the 30th cycle in the evaluation of the cycle characteristics.

$$Capacity retention rate ( \% ) = ( a discharge capacity of the 30 th cycle / a discharge capacity of the first cycle ) \times 100$$

### (5) Energy Density Retention Rate

The energy density retention rate was calculated by the following expression from the respective Wh capacities (per active substance weight) in discharge of the first cycle and the 30th cycle in the evaluation of the cycle characteristics.

$$Energy density retention rate ( \% ) = ( a discharge Wh capacity of the 30 th cycle / a discharge Wh capacity of the first cycle ) \times 100$$

TABLE 6

| | | | | | Energy |
|---|---|---|---|---|---|
| | First-Cycle | First-Cycle | 30th-Cycle | | Density |
| | Charge | Discharge | Discharge | Capacity | Retention |
| | Capacity | Capacity | Capacity | Retention Rate | Rate |
| | (mAh/g) | (mAh/g) | (mAh/g) | (%) | (%) |
| Example 1 | 202 | 172 | 174 | 101.5 | 101.5 |
| Comparative | 195 | 168 | 165 | 98.0 | 97.7 |
| Example 1 | | | | | |
| Comparative | 162 | 160 | 156 | 97.3 | 97.2 |
| Example 4 | | | | | |
| Comparative | 201 | 173 | 171 | 98.9 | 98.4 |
| Example 5 | | | | | |

TABLE 7

| | | | | | Energy |
|---|---|---|---|---|---|
| | First-Cycle | First-Cycle | 30th-Cycle | | Density |
| | Charge | Discharge | Discharge | Capacity | Retention |
| | Capacity | Capacity | Capacity | Retention Rate | Rate |
| | (mAh/g) | (mAh/g) | (mAh/g) | (%) | (%) |
| Example 2 | 203 | 176 | 177 | 100.4 | 100.1 |
| Comparative | 202 | 179 | 174 | 97.2 | 96.9 |
| Example 2 | | | | | |
| Comparative | 201 | 176 | 175 | 99.7 | 99.4 |
| Example 3 | | | | | |
| Comparative | 199 | 176 | 172 | 97.4 | 97.2 |
| Example 6 | | | | | |

### <Fabrication of Lithium Secondary Batteries 2>

By using the positive electrode active substance samples obtained in Examples 1 and 2 and Comparative Examples 1 and 2, and the LNMC samples, mixtures having compositions indicated in Table 8 were prepared by sufficient mixing by a household mixer, and were used as positive electrode active substance samples, respectively. Then, the pressure densities of the positive electrode active substance samples were measured by the same method as in the LNMC samples, and the results are shown in Table 8.

TABLE 8

| Positive | | | | | |
|---|---|---|---|---|---|
| Electrode | | Amount | | Amount | |
| Active | | Blended | | Blended | Pressure |
| Substance | | (parts by | | (parts by | Density |
| Sample | Sample | weight) | Sample | weight) | (g/cm³) |
| Mixture 1 | Example 1 | 70 | Example 2 | 30 | 3.1 |
| Mixture 2 | LNMC Sample | 70 | LNMC Sample | 30 | 3.0 |
| | 1 | | 2 | | |
| Mixture 3 | Comparative | 70 | Comparative | 30 | 3.0 |
| | Example 1 | | Example 2 | | |

95% by mass of the positive electrode active substance sample, 2.5% by mass of a graphite powder and 2.5% by mass of a polyvinylidene fluoride were mixed to make a positive electrode mixture, which was then dispersed in N-methyl-2-pyrrolidinone to prepare a kneaded paste. The kneaded paste was applied on an aluminum foil, and thereafter dried and pressed and punched out into a disc of 15 mm in diameter to thereby obtain a positive electrode plate.

By using the positive electrode plate, and by using each member of a separator, a negative electrode, a positive electrode, current collectors, mounting metal fittings, external terminals, an electrolyte solution and the like, a coin-type lithium secondary battery was fabricated. Among these, the negative electrode used was a metal lithium foil, and the electrolyte solution used was one in which 1 mol of LiPF₆ was dissolved in 1 L of a mixed solution of ethylene carbonate and methyl ethyl carbonate in 1:1.

Then, performance evaluations of the obtained lithium secondary batteries were carried out. The results are shown together in Table 9.

### <Performance Evaluations of the Batteries 2>

The fabricated coin-type lithium secondary batteries were each operated at room temperature under the following test conditions; and the cycle characteristics, the first-cycle charge capacity, the first-cycle discharge capacity (per active substance weight), the 30th-cycle charge capacity, the 30th-cycle discharge capacity (per active substance weight), the capacity retention rate, the energy density retention rate were evaluated by the same methods as in the performance evaluations of the batteries 1 described above. Further, the discharge capacity per volume was also evaluated, and the results are shown in Table 9. Then, the positive electrode active substance samples of Example 1 and Example 2 were also evaluated by the same methods. The results are shown in Table 9.

### (6) Discharge Capacity Per Volume

The discharge capacity per volume was determined by the following calculation expression from the initial discharge capacity and the electrode density.

$$Discharge capacity per volume ( mAh / {cm}^{3} ) = a first - cycle discharge capacity ( mAh / g ) \times an electrode density ( g / {cm}^{3} ) \times 0.95 ( proportion of the active substance in the applied material )$$

Then, the electrode density was calculated as a density of a positive electrode material by measuring a mass and a thickness of an electrode fabricated from a measuring object sample, and subtracting a mass and a thickness of a current collector therefrom.

Here, the positive electrode material was a mixture of 95% by mass of the positive electrode active substance sample, 2.5% by mass of the graphite powder and 2.5% by mass of the polyvinylidene fluoride, and the pressing pressure in the battery fabrication was made to be 0.38 ton/cm in linear pressure.

TABLE 9

| Positive | | | | | | |
|---|---|---|---|---|---|---|
| Electrode | First-Cycle | First-Cycle | Capacity | | | Discharge |
| Active | Charge | Discharge | Retention | Energy Density | Electrode | Capacity per |
| Substance | Capacity | Capacity | Rate | Retention Rate | Density | Volume |
| Sample | (mAh/g) | (mAh/g) | (%) | (%) | (g/cm³) | (mAh/cm³) |
| Mixture 1 | 201 | 171 | 100.4 | 100.3 | 2.99 | 486 |
| Mixture 2 | 200 | 174 | 98.9 | 98.8 | 3.01 | 498 |
| Mixture 3 | 196 | 169 | 98.0 | 97.4 | 3.03 | 486 |
| Example 1 | 202 | 172 | 101.5 | 101.5 | 2.85 | 466 |
| Example 2 | 203 | 176 | 100.4 | 100.1 | 2.68 | 448 |

1. A positive electrode active substance for a lithium secondary battery, the positive electrode active substance comprising a lithium nickel manganese cobalt composite oxide particle represented by the following general formula (1):
LiₓNi_{y}Mn_{z}CoₜMₚO₁₊ₓ (1)
wherein M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1; and being made to contain Ti as solid solution,
wherein the lithium nickel manganese cobalt composite oxide particle has, in the depth direction from the surface, a first region where an atomic % by mol of Ti with respect to the total of Ni, Co and Ti is 4.0 at % or higher, and a second region where the atomic % by mol of Ti with respect to the total of Ni, Co and Ti is lower than 4.0 at %; and
comprises a lithium nickel manganese cobalt composite oxide represented by the general formula (1), exhibiting a single phase in X-ray diffractometry.

2. The positive electrode active substance for a lithium secondary battery according to claim 1, wherein a content of Ti in the lithium nickel manganese cobalt composite oxide particle is, in terms of atom, with respect to the total amount of Ni, Mn, Co and M therein, 0.01 to 5.00% by mol as Ti.

3. The positive electrode active substance for a lithium secondary battery according to claim 1, wherein a content of remaining alkali in the positive electrode active substance is 1.20% by mass or lower.

4. The positive electrode active substance for a lithium secondary battery according to claim 1, wherein an atomic % by mol of Ti in the particle surface of the positive electrode active substance with respect to the total of Ni, Co and Ti therein is 6.0 at % or higher.

5. The positive electrode active substance for a lithium secondary battery according to claim 1, wherein a ratio (A/B) of an atomic % by mol (A) of Ti with respect to the total of Ni, Co and Ti at 0 nm in the depth direction to an atomic % by mol (B) of Ti with respect to the total of Ni, Co and Ti at 330 nm in the depth direction is 10.0 or higher.

6. The positive electrode active substance for a lithium secondary battery according to claim 1, wherein the positive electrode active substance is obtained by dry mixing a lithium nickel manganese cobalt composite oxide particle represented by the following general formula (1):
LiₓNi_{y}Mn_{z}CoₜMₚO₁₊ₓ (1)
wherein M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1, with a Ti-containing oxide to adhere the Ti-containing oxide on the particle surface of the lithium nickel manganese cobalt composite oxide particle to thereby obtain a composite oxide particle having the Ti-containing oxide adhered thereon, and thereafter heat-treating the composite oxide particle having the Ti-containing oxide adhered thereon at 750° C. or higher and 1,000° C. or lower.

7. The positive electrode active substance for a lithium secondary battery according to claim 1, wherein the positive electrode active substance is a mixture of large particles having an average particle diameter of 7.5 to 30.0 μm and small particles having an average particle diameter of 0.50 to 7.5 μm.

8. The positive electrode active substance for a lithium secondary battery according to claim 7, wherein a mixing ratio of the large particles to the small particles is, in mass ratio, from 7:13 to 19:1.

9. The positive electrode active substance for a lithium secondary battery according to claim 7, wherein the mixture has a pressure density in compression treatment at 0.65 tonf/cm² of 2.7 g/cm³ or higher.

10. A method for producing a positive electrode active substance for a lithium secondary battery, the method comprising: dry mixing a lithium nickel manganese cobalt composite oxide particle represented by the following general formula (1):
LiₓNi_{y}Mn_{z}CoₜMₚO₁₊ₓ (1)
wherein M denotes one or two or more metal elements selected from Al, Zr, Cu, Fe, Sr, Ca, V, Mo, Bi, Nb, Si, Zn, Ga, Ge, Sn, Ba, W, Na and K; and x denotes 0.98≤x≤1.20, y denotes 0.30≤y<1.00, z denotes 0<z≤0.50, t denotes 0<t≤0.50, p denotes 0≤p≤0.05, and y+z+t+p=1, with a Ti-containing oxide to adhere the Ti-containing oxide on the particle surface of the lithium nickel manganese cobalt composite oxide particle to thereby obtain a composite oxide particle having the Ti-containing oxide adhered thereon; and thereafter heat-treating the composite oxide particle having the Ti-containing oxide adhered thereon at 750° C. or higher and 1,000° C. or lower.

11. The method for producing a positive electrode active substance for a lithium secondary battery according to claim 10, wherein the Ti-containing oxide is TiO₂.

12. A lithium secondary battery comprising the positive electrode active substance for a lithium secondary battery according to claim 1.
